(19) United States
(12) Patent Application Publication
(10) Pub. No.: US 2006/0077886 A1
(43) Pub. Date: Apr. 13, 2006

(54) Transmission apparatus and method for a base station using block coding and cyclic delay diversity techniques in an OFDM mobile communication system

(75) Inventors: Hyun-Seok Oh, Nam-gu (KR); Sang-Hyo Kim, Suwon-si (KR); Sung-Soo Kim, Seoul (KR); Min-Goo Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/246,245

(22) Filed: Oct. 11, 2005

(30) Foreign Application Priority Data
Oct. 13, 2004 (KR) 2004-81713

(51) Int. Cl. H04J 11/00

(52) U.S. Cl. 370/208

(57) ABSTRACT

An apparatus and method are provided for efficiently supporting transmit diversity for identical broadcast signals transmitted from at least two base stations (BSs). A radio network controller (RNC) considers a radio channel state of a mobile station (MS) and sends information for implementing diversity to a plurality of BSs located in one cell configured by three sectors. Each of the BSs is provided with at least two transmit antennas. The BSs within the cell perform space-time block coding on data to be transmitted according to the information, apply different cyclic delays to the data, and transmit the data to the MS through the at least two transmit antennas.

### PRIORITY

This application claims benefit under 35 U.S.C. § 119(a) of Korean Patent Application No. 2004-81713, filed in the Korean Intellectual Property Office on Oct. 13, 2004, the entire disclosure of which is hereby incorporated by reference.

### BACKGROUND OF THE INVENTION

1. Field of the Invention

The present invention generally relates to supporting transmit diversity in an orthogonal frequency division multiplexing/code division multiple access (OFDM/CDMA) communication system. More particularly, the present invention relates to an apparatus and method for efficiently supporting transmit diversity for identical broadcast signals transmitted from base stations (BSs) with at least two antennas.

2. Description of the Related Art

With the increase in content for mobile communication services, the demand of users for multimedia, such as video, audio, text, digital broadcasting, and so on, as well as voice service is explosively increasing. To meet this demand, a large amount of research and development is being conducted on orthogonal frequency division multiplexing (OFDM) corresponding to one method for efficiently transmitting high-speed data. The OFDM scheme is considered a fourth-generation (4G) mobile communication, in other words a next-generation mobile communication technology. Moreover, the OFDM scheme is being standardized along with the development of ultra high-speed packet transmission technology.

A mobile communications station (MS) can perform communications by receiving a signal transmitted from an associated cell located in the same mobile communication system as the MS. For communications to occur, a suitable signal transmission scheme is required that considers shadowing areas in which a transmitted signal is weakened, hot spot areas in which a large number of MSs are concentrated, or rural areas in which a small number of MSs are available.

A base station (BS) uses transmit diversity to ensure a transmission signal for an MS located in a cell covered by the BS. Because, a signal transmitted from another cell neighboring to the cell of the BS serves as a factor capable of reducing communication performance of the MS.

A need exists for a transmission structure that can support macro diversity in an associated cell and support more suitable diversity using multiple antennas of BSs within the cell, when identical broadcast signals are transmitted from a cell of a BS and its neighbor cell to support a broadcast service.

### SUMMARY OF THE INVENTION

An object of the present invention to provide a transmission apparatus and method for use in a base station (BS) that can support transmit diversity in an orthogonal frequency division multiplexing/code division multiple access (OFDM/CDMA) communication system.

Another object of the present invention is to provide a transmission apparatus and method for use in a base station (BS) that can efficiently support transmit diversity for identical broadcast signals transmitted from BSs with at least two antennas in an orthogonal frequency division multiplexing/code division multiple access (OFDM/CDMA) communication system.

In accordance with an embodiment of the present invention for achieving the above and other objects, there is provided a method for using block coding and cyclic delay diversity techniques in a base station (BS) of an orthogonal frequency division multiplexing (OFDM) mobile communication system. The method comprises the steps of evaluating a radio channel state of a mobile station (MS) in a radio network controller (RNC) and sending information for implementing diversity to a plurality of BSs located in one cell. The cell is configured by three sectors and each of the BSs are provided with at least two transmit antennas. The method further comprises performing space-time block coding on data to be transmitted from the BSs according to the information sent for implementing diversity, applying different cyclic delays to the data, and transmitting the data to the MS through the at least two transmit antennas.

In accordance with another embodiment of the present invention for achieving the above and other objects, there is provided a method for using block coding and cyclic delay diversity techniques in a base station (BS) of an orthogonal frequency division multiplexing (OFDM) mobile communication system. The method comprises evaluating a radio channel state of a mobile station (MS) in a radio network controller (RNC) and sending information for implementing diversity to a plurality of BSs located in one cell configured by three sectors. Each of the BSs is provided with at least two transmit antennas. The method may also comprise performing space-frequency block coding on data to be transmitted from the BSs according to the information sent for implementing diversity, applying different cyclic delays to the data, and transmitting the data to the MS through the at least two transmit antennas provided in each BS.

In accordance with another embodiment of the present invention for achieving the above and other objects, there is provided an apparatus for a base station (BS) using block coding and cyclic delay diversity techniques in an orthogonal frequency division multiplexing (OFDM) mobile communication system. The apparatus comprises a space-time coding block for sequentially receiving a first N-length data stream and a second N-length data stream, the space-time coding block being configured to perform coding to generate N-length symbol vectors according to a designated space-time code, and output the N-length symbol vectors in parallel. The apparatus may also comprise a plurality of inverse transform processors for outputting N-length multicarrier symbols based on a time domain transformation from the N-length symbol vectors, the inverse transform processors corresponding to the number of transmit antennas, and delay elements for delaying the N-length multicarrier symbols output from the inverse transform processors by designated delay values and outputting the delayed symbols.

In accordance with yet another embodiment of the present invention for achieving the above and other objects, there is provided an apparatus for a base station (BS) using block coding and cyclic delay diversity techniques in an orthogonal frequency division multiplexing (OFDM) mobile communication system. The apparatus comprises a space-frequency coding block for receiving a first N-length data stream and a second N-length data stream, the space-frequency coding block being configured to sequentially input first N/2-length data and second N/2-length data, combining the two data streams, and output N-length symbol vectors in parallel according to a space-frequency code. The apparatus may also comprise a plurality of inverse transform processors for outputting N-length multicarrier symbols based on a time domain transformation from the N-length symbol vectors, the inverse transform processors corresponding to the number of transmit antennas, and delay elements for delaying the N-length multicarrier symbols output from the inverse transform processors by designated delay values and outputting the delayed symbols.

### BRIEF DESCRIPTION OF THE DRAWINGS

The above and other features and advantages of the present invention will be more apparent from the description of certain exemplary embodiments within the following detailed description taken in conjunction with the accompanying drawings, in which:

FIG. 1 illustrates an exemplary cell structure in which the present invention is applied;

FIG. 2 shows a block diagram illustrating a transmission structure of a base station (BS) using space-time block coding (STBC) and cyclic delay diversity techniques in accordance with an exemplary embodiment of the present invention;

FIG. 3 shows a block diagram illustrating details of the cyclic delay diversity technique illustrated in FIG. 2;

FIG. 4 shows a block diagram illustrating details of the STBC technique illustrated in FIG. 2;

FIG. 5 shows a block diagram illustrating a transmission structure of a BS using space-frequency block coding (SFBC) and cyclic delay diversity techniques in accordance with another exemplary embodiment of the present invention;

FIG. 6 shows a block diagram illustrating details of the SFBC technique illustrated in FIG. 5;

FIG. 7 shows a block diagram illustrating a structure for controlling a transmission operation of the BS in a radio network controller (RNC) in accordance with an aspect of the present invention; and

FIG. 8 depicts a graph illustrating a performance comparison between a conventional system and a system in accordance with the present invention.

Throughout the drawings, like reference numbers should be understood to refer to like elements, features and structures.

### DETAILED DESCRIPTION OF EXEMPLARY EMBODIMENTS

The matters exemplified in this description are provided to assist in a comprehensive understanding of various embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness. It is to be understood that the phraseology and terminology employed herein are for the purpose of description and should not be regarded as limiting the present invention.

Certain embodiments of the present invention propose a transmission apparatus and method of using a base station (BS) for providing more suitable transmit diversity in a mobile communication system supporting orthogonal frequency division multiplexing/high-speed downlink packet access (OFDM/HSDPA).

A transmission structure of a BS using space-time block coding (STBC) and cyclic delay diversity techniques in accordance with an embodiment of the present invention will be described. Moreover, a transmission structure of a BS using space-frequency block coding (SFBC) and cyclic delay diversity techniques in accordance with a another embodiment of the present invention will be described. BSs are provided with at least two antennas that transmit identical signals with different delay times, such that a mobile station (MS) ensures performance gain.

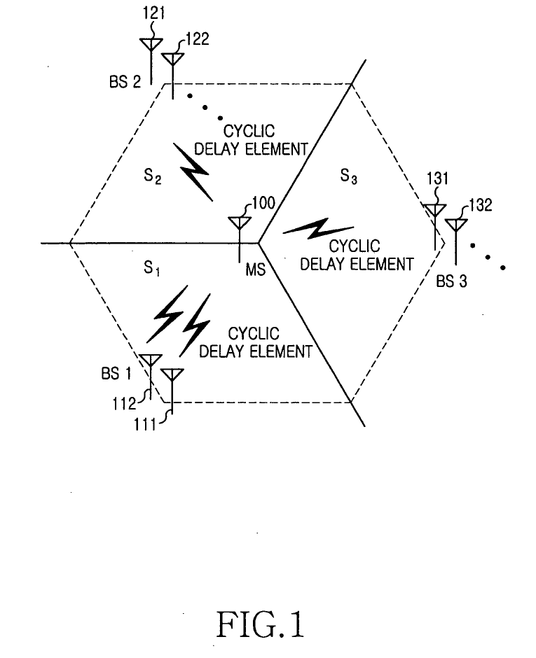

FIG. 1 illustrates an exemplary cell structure in which the present invention is applied. Referring to FIG. 1, MS 100 is a terminal for receiving a broadcast service through a broadcast channel in a mobile communication system. The MS 100 may pass through a hot spot area within the heart of the city, or a rural or mountain area in which available signal is weak. Multipath channel characteristics differ according to geographic location.

For example, when MS 100 is located within a hot spot area in the heart of the city, where, typically, the number of neighboring cells is large and the distance between the cells is short, MS 100 receives a sufficient number of multipath channels through multiple paths even though cyclic delay diversity does not exist. On the other hand, when MS 100 moves to a remote rural or mountain area, the distance between cells is far and the number of multipath channels are insufficient. MS 100 can obtain fading gain from multipath channels transmitted from BSs of each cell by applying a cyclic diversity demodulation scheme to signals transmitted from cells.

As shown in FIG. 1, MS 100 is located in an overlapping area between three sectors covered by three different BSs. Each BS transmits a broadcast channel to the MS 100 located in the cell using at least one transmit antenna, respectively. The BSs transmit STBC or SFBC signals through multiple antennas, 111, 112, 121, 122, 131, and 132. MS 100 receives data through an identical frequency from each of the three BSs, BS1, BS2, and BS3. Data with different cyclic delays is transmitted from BS1, BS2, and BS3. MS 100 receives the data with the different cyclic delays through different paths, thereby obtaining the effect of macro diversity.

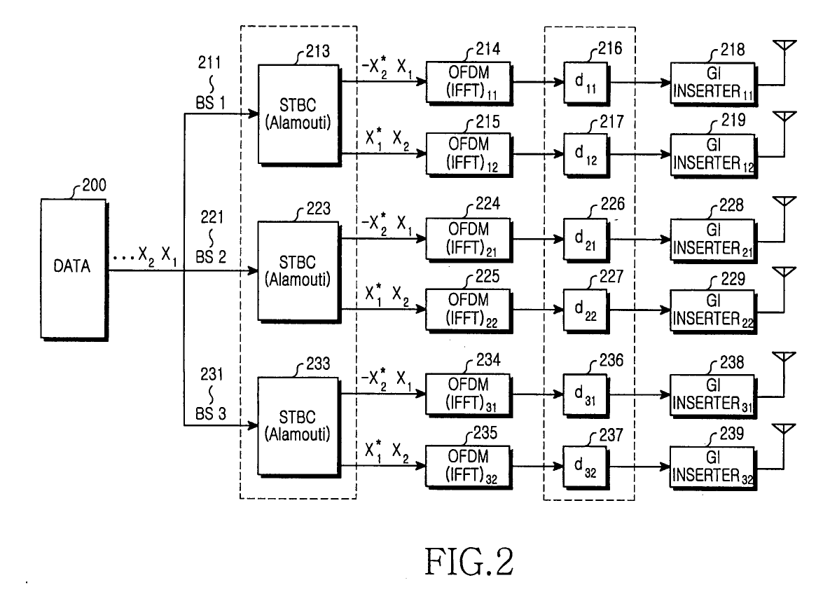

FIG. 2 is a block diagram illustrating a transmission structure of a BS in accordance with an exemplary embodiment of the present invention. In this embodiment, it is assumed that a channel is constant during a period of at least two OFDM symbols.

Referring to FIG. 2, an N-data stream 200 is transferred to three BSs, BS1 211, BS2 221, and BS3 231. At this time, data stream 200 is provided in the sequence of X₁=[X₁(0), X₁(1), . . . , X₁(N/2−1)]^{T} and X₂=[X₂(0), X₂(1), . . . , X₂(N/2−1)]^{T}. The BS has a parallel transmission structure in which input data X₁ and X₂ use OFDM multicarriers. STBC blocks 213, 223, and 233 provided in BS1, BS2, and BS3 perform STBC on the input data stream in an N-length vector unit and output STBC signals, respectively.

STBC blocks 213, 223, and 233 perform STBC on the data stream 200 of sequentially input data X₁ and X₂, then output STBC signals to inverse fast Fourier transform (IFFT) processors 214, 215, 224, 225, 234, and 235. The IFFT processors 214, 215, 224, 225, 234, and 235 generate N multicarrier signals based on a process of multiple division from a sequentially input data stream using an IFFT operation, in other words, an OFDM modulation operation and the IFFT possessors transform N parallel OFDM signals of the OFDM modulation into time domain signals, respectively.

The time domain signals output from the IFFT processors 214, 215, 224, 225, 234, and 235 are artificially delayed by delay elements, d₁₁ 216, d₁₂ 217, d₂₁ 226, d₂₂ 227, d₃₁ 236, and d₃₂ 237, such that cyclic delay diversity can be obtained. That is, a cyclic delay level associated with each antenna is controlled such that the maximum diversity can be obtained. The delay elements, d₁₁ 216, d₁₂ 217, d₂₁ 226, d₂₂ 227, d₃₁ 236, and d₃₂ 237, correspond to the number of antennas and are controlled such that they have one of delay values d1 and d2, respectively. The delay elements output the delayed time domain signal to the guard interval (GI) inserters.

Guard interval (GI) inserters 218, 219, 228, 229, 238, and 239 detect time domain signals corresponding to cyclic prefixes (CPs) from the data of N OFDM samples output by the delay elements, d₁₁ 216, d₁₂ 217, d₂₁ 226, d₂₂ 227, d₃₁ 236, and d₃₂ 237. Then, the GI inserters 218, 219, 228, 229, 238, and 239 perform a subtraction operation using a predetermined CP value, and arrange the detected CP signals in a predefined position on the time axis. A CP is set to a GI of G samples, and is inserted before the OFDM sample data. Then, the OFDM sample data containing the GI is output. Hereinafter, an OFDM symbol into which a GI has been inserted is referred to as an OFDM transmission symbol. The BS transmits a generated OFDM transmission symbol through at least one antenna.

As described above in relation to FIGS. 1 and 2, the three BSs transmit identical signals on N-length subcarriers during a two-symbol period through three pairs of antennas (111, 112; 121, 122; 131, 132) in accordance with an exemplary embodiment of the present invention. The cyclic delay is applied for each antenna of the BS. During the two-symbol period, a space-time block code is formed on one subchannel. A cyclic delay controller controls a cyclic delay level associated with each antenna such that the maximum diversity can be obtained. Within one BS, for example, d₁₁=d₁₂ can be set.

An MS at the receiving side estimates two channels as it detects that two transmit antennas are present. The MS obtains space-time diversity using a space-time block code reception method. Cyclic delay diversity is obtained from signals transmitted through three antennas.

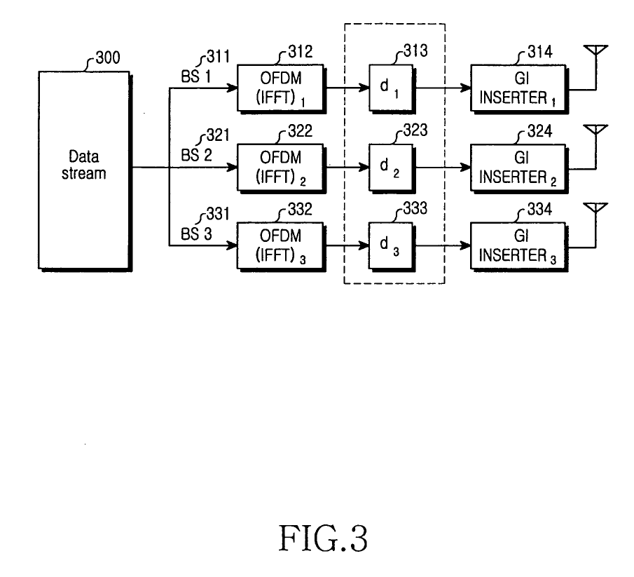

FIG. 3 shows a block diagram illustrating details of the cyclic delay diversity technique illustrated in FIG. 2. The structure of FIG. 3 transmits identical data streams 300 from three BSs, BS1, BS2, and BS3, when the three BSs are located in one cell.

Data stream 300 is simultaneously transferred to the three BSs, BS1, BS2, and BS3. In BS1 311, an IFFT processor 312 generates data of N OFDM samples from the sequentially input data stream 300 and outputs the data of N OFDM samples in parallel. A delay element d₁ 313 delays the OFDM sample data, provides parallel output by a delay value d₁, then outputs the delayed data to GI inserter 314. GI inserter 314 copies data of the last G OFDM samples among the data of N OFDM samples configuring an OFDM symbol, and inserts the copied data before the OFDM symbol. The GI inserter 314 outputs the OFDM symbol into which the copied data has been inserted. An OFDM transmission symbol output from the GI inserter 314 is transmitted through an antenna.

In BS2 321, an IFFT processor 322 generates data of N OFDM samples from the sequentially input data stream 300 and outputs the data of N OFDM samples in the parallel fashion. A delay element d₂ 323 delays the OFDM sample data, provides parallel output by a delay value d₂, then outputs the delayed data to GI inserter 324. The delay value of d₂ is different from the delay value d₁ of delay element d₁ 313. GI inserter 324 copies data of the last G OFDM samples among the data of N OFDM samples configuring an OFDM symbol, and inserts the copied data before the OFDM symbol. The GI inserter 324 outputs the OFDM symbol into which the copied data has been inserted. An OFDM transmission symbol output from the GI inserter 324 is transmitted through an antenna.

In BS3 331, an IFFT processor 332 generates data of N OFDM samples from the sequentially input data stream 300 and outputs the data of N OFDM samples in the parallel fashion. A delay element 333 delays the OFDM sample data, provides parallel output by a delay value d₃, then outputs the delayed data to GI inserter 334. The delay value d₃ is different from the delay value d₁ of delay element d₁ 313, and the delay value d₂ of delay element d₂ 323. GI inserter 334 copies data of the last G OFDM sample among the data of N OFDM samples configuring an OFDM symbol, and inserts the copied data before the OFDM symbol. The GI inserter 334 outputs the OFDM symbol into which the copied data has been inserted. An OFDM transmission symbol output from the GI inserter 334 is transmitted through an antenna.

The three BSs, i.e., BS1, BS2, and BS3, are each provided with one antenna. Data stream 300 is transmitted from the antennas to the MS through different paths. The MS at the receiving side soft-combines the identical data streams 300 transferred through the different paths, such that the received data stream 300 is ensured.

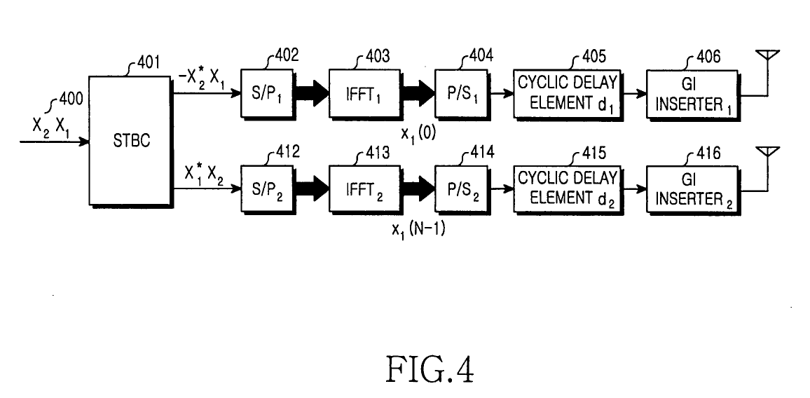

FIG. 4 shows a block diagram illustrating details of the STBC technique illustrated in FIG. 2. Referring to FIG. 4, one BS transmits data through multiple paths using two antennas. That is, the BS performs an STBC operation and an OFDM modulation operation for 2N modulated symbol elements present in two symbols and outputs data to the two antennas.

STBC block 401 sequentially receives OFDM symbols X₁=[X₁(0), X₁(1), . . . , X₁(N−1)]^{T} and X₂=[X₂(0), X₂(1), . . . , X₂(N−1)]^{T} in sequence, then simultaneously outputs 2N vector data elements of STBC in parallel. That is, the STBC block 401 codes data input in the sequence of X₁ and X₂ to generate and output the coded data X₁ and −X₂* for a first antenna. Moreover, the STBC block 401 generates and outputs the coded data in the sequence of X₂ and X₁* for a second antenna.

Serial-to-parallel (S/P) converter 402 sequentially receives vector data X₁ and −X₂* with a unit of N elements output from STBC block 401 and outputs N parallel data elements to IFFT processor 403. IFFT processor 403 processes the parallel data from S/P converter 402, then outputs data of N OFDM samples [X₁(0), X₁(1), . . . , X₁(N−1)] in parallel. A first parallel-to-serial (P/S) converter 404 receives the OFDM sample data output from the IFFT processor 403 in parallel, converts the parallel data into serial data, and outputs the serial data to delay element 405. Delay element 405 applies a cyclic delay value d₁ to the data of N OFDM samples and outputs the delayed data to GI inserter 406. GI inserter 406 copies data of the last G OFDM samples among the data of N OFDM samples configuring an OFDM symbol, and inserts the copied data before the OFDM symbol. The GI inserter 406 outputs a signal of [x₁(d₁−g), x₁(d₁−1), x₁(d₁−2)/x₁(d₁), x₁(d₁+1), x₁(d₁−1)]. An OFDM transmission symbol with the delay value d₁ is transmitted through a first antenna.

S/P converter 412 sequentially receives vector data X₂ and X₁* with a unit of N elements output from STBC block 401 and outputs N parallel data elements to IFFT processor 413. IFFT processor 413 processes the parallel data from S/P converter 412, then outputs data of N OFDM samples in the parallel fashion. A second P/S converter 414 receives the OFDM sample data output from the IFFT processor 413 in parallel, converts the parallel data into serial data, and outputs the serial data to delay element 415. Delay element 415 applies a cyclic delay value d₂ to the data of N OFDM samples and outputs the delayed data to GI inserter 416. GI inserter 416 copies data of the last G OFDM samples among the data of N OFDM samples configuring an OFDM symbol, and inserts the copied data before the OFDM symbol. The GI inserter 416 outputs a signal of [x₁(d₂−g), x₁(d₁−1), x₁(d₂−2)/x₁(d₂), x₁(d₂+1), x₁(d₂−1)]. An OFDM transmission symbol with the delay value d₂ is transmitted through a second antenna.

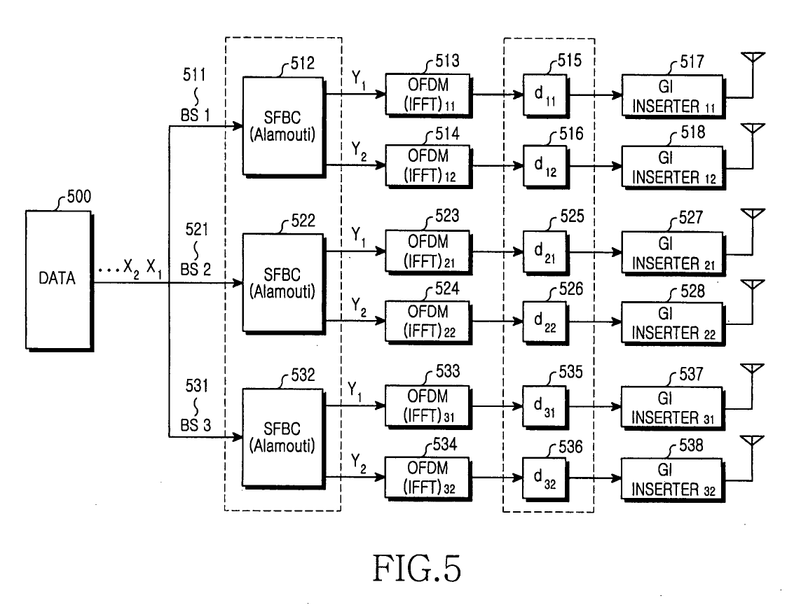

FIG. 5 shows a block diagram illustrating a transmission structure of a BS using SFBC and cyclic delay diversity techniques in accordance with another exemplary embodiment of the present invention. The structure of FIG. 5 performs an SFBC operation and an OFDM modulation operation for N modulated symbol elements present in an OFDM symbol and outputs data to two antennas. N/2-length vectors are sequentially input to an SFBC block. Referring to FIG. 5, an N-data stream 500 to be transmitted are transferred to three BSs, BS1 511, BS2 521, and BS3 531. At this time, the data stream 500 is input in the sequence of X₁=[X₁(0), X₁(1), . . . , X₁(N/2−1)]^{T} and X₂=[X₂(0), X₂(1), . . . , X₂(N/2−1)]^{T}.

SFBC blocks 512, 522, and 532 combine two vector inputs, apply a space-time block code on a frequency domain, and output N/2 number of Y₁ data elements and N/2 number of Y₂ data elements for one OFDM symbol. The Y₁ and Y₂ data is output to IFFT processors 513, 514, 523, 524, 533, and 534. The IFFT processors 513, 514, 523, 524, 533, and 534 perform an IFFT operation, in other words, an OFDM modulation operation on the Y₁ and Y₂ data, and transforms N parallel OFDM signals based on the OFDM modulation into time domain signals. The time domain signals output from the IFFT processors are artificially delayed and output by delay elements, d₁₁ 515, d₁₂ 516, d₂₁ 525, d₂₂ 526, d₃₁ 535, and d₃₂ 536, such that cyclic delay diversity can be obtained.

GI inserters 517, 518, 527, 528, 537, and 538 detect time domain signals corresponding to CPs from the data of N OFDM samples output from delay elements, d₁₁ 515, d₁₂ 516, d₂₁ 525, d₂₂ 526, d₃₁ 535, and d₃₂ 536. Then, the GI inserters 517, 518, 527, 528, 537, and 538 perform a subtraction operation using a predetermined CP value, and arrange the detected CP signals in a predefined position on the time axis. A CP is set to a GI of G samples, and is inserted before the OFDM sample data. Then, the OFDM sample data containing the GI is output. Hereinafter, an OFDM symbol into which a GI has been inserted is referred to as an OFDM transmission symbol. The BS sends a generated OFDM transmission symbol through at least one antenna.

In accordance with the exemplary embodiment described above, a space-frequency block code is configured by combining symbols mapped to two adjacent subcarriers and cyclic delay is applied after the IFFT processors 513, 514, 523, 524, 533, and 534, such that macro diversity is obtained. Cyclic delay is applied within the BS according to the condition d₁₁=d₁₂, d₂₁=d₂₂, and d₃₁=d₃₂, such that orthogonality in the space-frequency block code is not destructed.

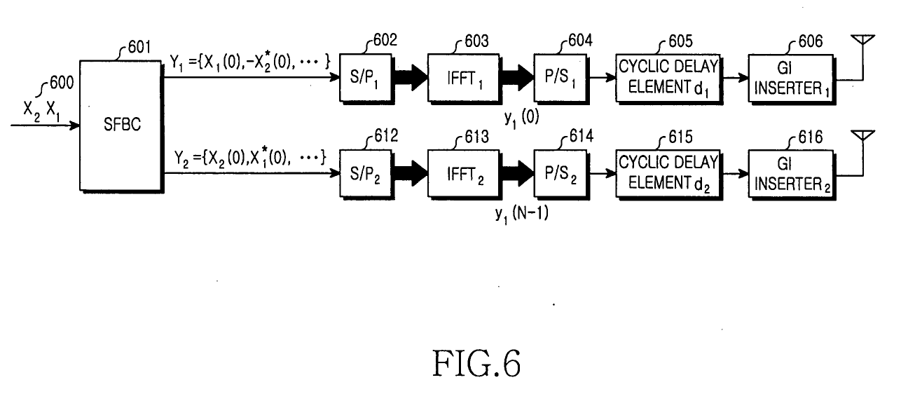

FIG. 6 shows a block diagram illustrating details of the SFBC technique illustrated in FIG. 5. The structure of FIG. 6 receives two N/2-length vectors and outputs OFDM symbols of SFBC.

SFBC block 601 receives X₁ and X₂ in order. X₁ is input in sequence of X₁=[X₁(0), X₁(1), . . . , X₁(N/2−1)]^{T} and X₂ is input in sequence of X₂=[X₂(0), X₂(1), . . . , X₂(N/2−1)]^{T}. The SFBC block 601 outputs N-length Y₁ and Y₂ vectors. Y₁=[X₁(0), −X₂*(0), X₁(1), −X₂*(1), . . . , X₁(N/2−1), −X₂*(N/2−1)]^{T}. Y₂=[X₂(0), X₁*(0), . . . , X₂(N/2−1), X₁*(N/2−1)]^{T}. That is, the SFBC block 601 configures one space-frequency block code by combining elements of the Y₁ and Y₂ vectors two by two.

Serial-to-parallel (S/P) converter 602 sequentially receives N-length vector data of [X₁(0), −X₂*(0), X₁(1), −X₂*(1), . . . , X₁(N/2−1), −X₂*(N/2−1)]^{T} output from SFBC block 601, then outputs N parallel data elements. IFFT processor 603 processes the parallel data of S/P converter 602, then outputs data of N OFDM samples of y₁(0).

Parallel-to-serial (P/S) converter 604 receives the OFDM sample data output from IFFT processor 603 in parallel, converts the parallel data into serial data, and outputs the serial data. A delay element d₁ 605 applies a cyclic delay value d₁ to the data of N OFDM samples and outputs the delayed data.

GI inserter 606 copies data of the last G OFDM sample among the data of N OFDM samples configuring an OFDM symbol, and inserts the copied data before the OFDM symbol. The GI inserter 606 outputs a signal of [y₁(d₁−g), y₁(d₁−1), y₁(d₁−2)/y₁(d₁), y₁(d₁+1), y₁(d₁₋₁)]. An OFDM transmission symbol with the delay value d₁ is transmitted through a first antenna.

S/P converter 612 sequentially receives N-length vector data of [X₂(0), X₁*(0), . . . , X₂(N/2−1), X₁*(N/2−1)]^{T} output from SFBC block 601, then outputs N parallel data elements. IFFT processor 613 processes the parallel data of S/P converter 612, then outputs data of N OFDM samples of y₁(N−1).

P/S converter 614 receives the OFDM sample data output from the IFFT processor 613 in parallel, converts the parallel data into serial data, and outputs the serial data. A delay element d₂ 615 applies a cyclic delay value d₂ to the data of N OFDM samples and outputs the delayed data. GI inserter 616 copies data of the last G OFDM samples among the data of N OFDM samples configuring an OFDM symbol, and inserts the copied data before the OFDM symbol. The GI inserter 616 outputs a signal of [y1(d₂−g), y₁(d₂−1), y₁(d₂−2)/y₁(d₂), y₁(d₂+1), y₁(d₂−1)]. An OFDM transmission symbol with the delay value d₂ is transmitted through a second antenna.

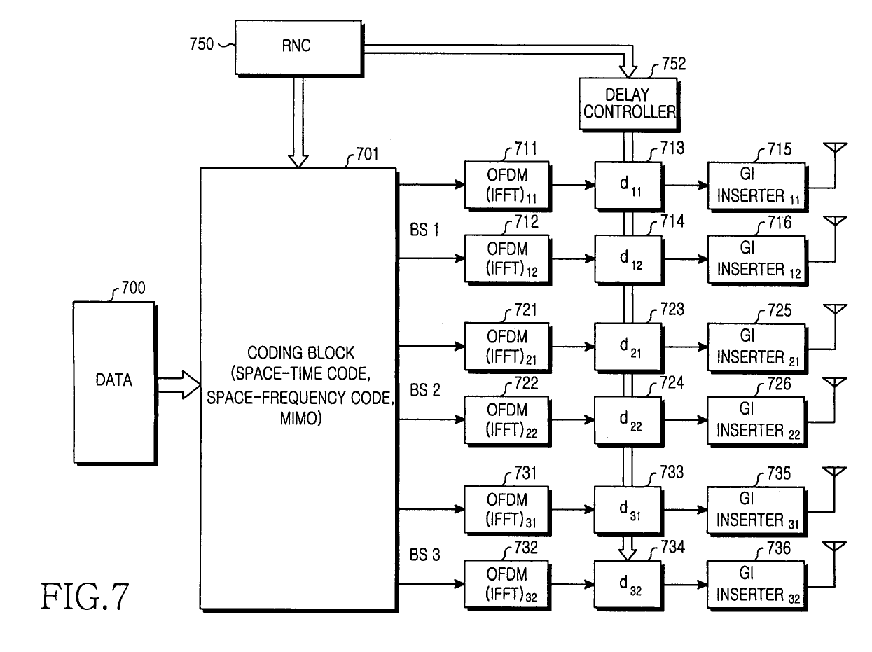

FIG. 7 shows a block diagram illustrating a structure for controlling a transmission operation of a BS in a radio network controller (RNC) in accordance with an aspect of the present invention. Referring to FIG. 7, RNC 750 controls all BSs under its control such that they can simultaneously transmit identical data. Therefore, macro diversity is provided to an MS.

RNC 750 considers the region and geographical features within which an MS is located, the number and location of MSs within the sectors configuring an associated cell, or reception states of MSs, and performs a control operation to provide antenna transmission and cyclic delay techniques most suitable for BSs of the cell and sectors. RNC 750 is provided with a plurality of antennas, and performs a control operation such that the antennas transmit identical data with different delay values according to a control operation of a cyclic delay controller 752. The control operation can be updated in a predetermined period or can be fixed if needed. The cyclic delay value must be greater than the maximum delay spread in a multipath channel such that a maximum diversity effect can be obtained.

To achieve this effect, RNC 750 applies a control signal to a coding block 701. In response to the control signal, coding block 701 performs a space-time or space-frequency coding operation on data stream 700. Moreover, RNC 750 performs a control operation such that various transmit diversity or multiple-input multiple-output (MIMO) structures are implemented. That is, a transmission method based on diversity can be independently performed in each BS or can be performed according to a control signal of RNC 750. Here, RNC 750 defines the above-described serviceable transmission schemes in several modes, stores mode information, allocates predetermined bits to an associated mode, sends the bits to each BS, and controls transmission structure. The processing of data from BS1, BS2, and BS3 through IFFT processors 711, 712, 721, 722, 731, and 732, then through delay elements d₁₁ 713, d₁₂ 714, d₂₁ 723, d₂₂ 724, d₃₁ 733, and d₃₂ 734, subject to control of delay controller 752, then to GI inserters 715, 716, 715, 726, 735, and 736, occurs in a manner similar to the technique illustrated in FIG. 5, above.

The example in which each BS is provided with two transmit antennas has been described in relation to FIG. 7. Alternatively, each BS may be provided with more than two transmit antennas. For example, BSs sharing a broadcast channel may be provided with at least two or four antennas.

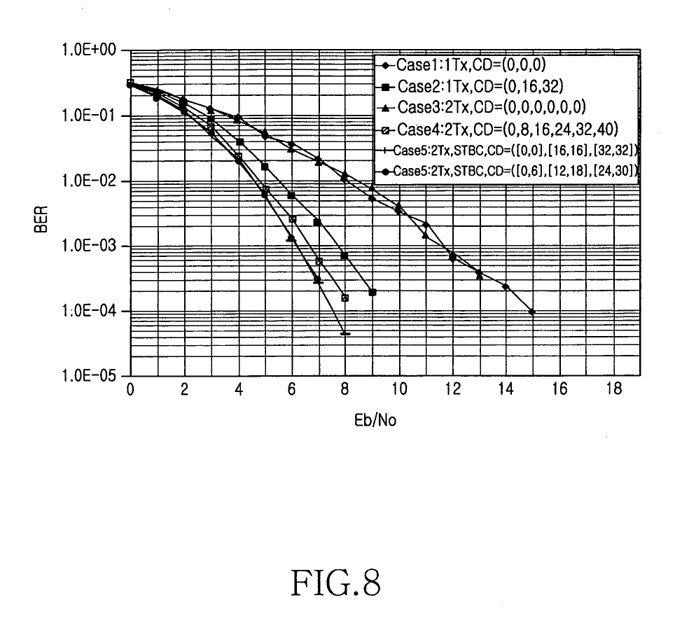

FIG. 8 shows a graph illustrating a performance comparison between a proposed system and a conventional system. In FIG. 8, it is assumed that an MS is located between three sectors covered by three BSs, and that a BS is provided with two transmit antennas for each sector. Moreover, it is assumed that a structure is provided which transmits identical signals through the three neighboring sectors and applies the cyclic delay to each of the identical signals.

Table 1 shows parameters considered by an OFDM system. In this example, an FFT size is N=64; the channel length and the CP length each correspond to 4 samples; an interleaving scheme uses (16×4) symbol interleaving; and a channel code is a convolutional code with the constraint length of 7.

TABLE 1

| Parameters | Values |
|---|---|
| FFT size (points) | 64 |
| Channel length | 4 samples |
| Cyclic prefix | 4 samples |
| Channel profiles | Exponentially decaying power with 4 multipaths |
| Coding scheme | 64 states, ½ rate, convolutional coding with |
| | soft Viterbi decoding |
| Interleaving | 16 by 4 symbol interleaving |
| Modulation | Quadrature Phase Shift Keying (QPSK) |

In reference to FIG. 8, case 1 is a case where each BS with one transmit antenna sends an identical signal. Case 2 is a case where each BS with one transmit antenna sends an identical signal and a cyclic delay diversity of (0, 16, 32) is applied for identical signals. Case 3 is a case where each BS with two transmit antennas sends an identical signal. Case 4 is a case where each BS with two transmit antennas send an identical signal and a cyclic delay diversity of (0, 8, 16, 24, 32, 40) is applied for identical signals. Case 5 is a case where a space-time code is applied, each BS has two transmit antennas, and cyclic delay is applied between BSs in accordance with an aspect of the present invention. In this case, the BSs transmit identical signals by applying the same cyclic delay between transmit antennas within each BS.

On the other hand, Case 6 is a case where a space-time code is applied, each BS has two transmit antennas, and cyclic delay is applied between BSs in accordance with an aspect of the present invention. In this case, the BSs transmit identical signals by applying different cyclic delays between transmit antennas within each BS.

From the data of FIG. 8, it can be seen that when space-time coding and cyclic delay is applied to a coded signal in accordance with an aspect of the present invention, diversity performance is improved.

As is apparent from the above description, aspects of the present invention provide for maximizing transmission efficiency of a mobile station (MS) in a cell by ensuring macro diversity between base stations (BSs) and diversity using multiple antennas within a BS when a broadcast channel is transmitted in a mobile communication system using multiple carriers. Moreover, the present invention can obtain frequency diversity gain in a region in which sufficient gain cannot be obtained from multipath fading channels.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for using block coding and cyclic delay diversity techniques in a base station (BS) of an orthogonal frequency division multiplexing (OFDM) mobile communication system, the method comprising:
evaluating a radio channel state of a mobile station (MS) in a radio network controller (RNC);
sending information for implementing diversity to a plurality of BSs located in one cell configured by three sectors, each of the BSs being provided with at least two transmit antennas, the information is determining according to the radio channel state;
performing space-time block coding on data to be transmitted from the BSs according to the information sent;
applying different cyclic delays to the coded data; and
transmitting the delayed data to the MS through the at least two transmit antennas.

2. The method of claim 1, further comprising:
grouping signals transmitted through first and second antennas on a sector-by-sector basis; and
performing channel estimation in the MS.

3. A method for using block coding and cyclic delay diversity techniques in a base station (BS) of an orthogonal frequency division multiplexing (OFDM) mobile communication system, the method comprising:
evaluating a radio channel state of a mobile station (MS) in a radio network controller (RNC);
sending information for implementing diversity to a plurality of BSs located in one cell configured by three sectors, each of the BSs being provided with at least two transmit antennas, the information is determining according to the radio channel state;
performing space-frequency block coding on data to be transmitted from the BSs according to the information sent;
applying different cyclic delays to the coded data; and
transmitting the delayed data to the MS through the at least two transmit antennas provided in each BS.

4. The method of claim 3, further comprising the steps of:
applying an identical cyclic delay to multicarrier signals on which the space-frequency block coding has been performed in a BS located in each sector according to the information sent; and
transmitting the multicarrier signals to the MS through the at least two transmit antennas.

5. An apparatus for a base station (BS) using block coding and cyclic delay diversity techniques in an orthogonal frequency division multiplexing (OFDM) mobile communication system, the apparatus comprising:
a space-time coding block for sequentially receiving a first N-length data stream and a second N-length data stream, the space-time coding block being configured to perform coding to generate N-length symbol vectors according to a designated space-time code and output the N-length symbol vectors in a parallel fashion;
a plurality of inverse transform processors for outputting N-length multicarrier symbols based on a time domain transformation from the N-length symbol vectors, the inverse transform processors corresponding to the number of transmit antennas; and
delay elements for delaying the N-length multicarrier symbols output from the inverse transform processors by designated delay values and outputting the delayed symbols.

6. The apparatus of claim 5, wherein the BS comprises at least two transmit antennas.

7. The apparatus of claim 6, wherein the space-time coding block performs space-time coding on the first N-length data stream and the second N-length data stream in parallel according to the number of transmit antennas in response to control information applied from the RNC.

8. The apparatus of claim 7, wherein the delay elements comprise different delay values between transmit antennas within the BS for the N-length multicarrier symbols and comprise identical delay values between transmit antennas with identical sequence numbers between sectors.

9. An apparatus for a base station (BS) using block coding and cyclic delay diversity techniques in an orthogonal frequency division multiplexing (OFDM) mobile communication system, the apparatus comprising:
a space-frequency coding block for receiving a first N-length data stream and a second N-length data stream, the space-frequency coding block being configured to sequentially input first N/2-length data and second N/2-length data, combining the two data streams, and output N-length symbol vectors in parallel according to a space-frequency code;
a plurality of inverse transform processors for outputting N-length multicarrier symbols based on a time domain transformation from the N-length symbol vectors, the inverse transform processors corresponding to the number of transmit antennas; and
delay elements for delaying the N-length multicarrier symbols output from the inverse transform processors by designated delay values and outputting the delayed symbols.

10. The apparatus of claim 9, wherein the space-frequency coding block is configured to receive the first N-length data stream and the second N-length data stream according to control information applied from the RNC, perform N/2-length space-frequency block coding on the first and second N-length data streams in parallel according to the number of transmit antennas, and output the N-length symbol vectors.

11. The apparatus of claim 10, wherein the delay elements comprise identical delay values between transmit antennas within the BS for the N-length multicarrier symbols and comprise different delay values between transmit antennas between sectors.
